(19) United States
(12) Patent Application Publication
(10) Pub. No.: US 2018/0118218 A1
(43) Pub. Date: May 3, 2018

(54) METHOD AND APPARATUS FOR VEHICULAR ADAPTATION TO DRIVER STATE

(71) Applicant: FORD GLOBAL TECHNOLOGIES, LLC, Dearborn, MI (US)

(72) Inventor: James Andrew MILOSER, Saline, MI (US)

(21) Appl. No.: 15/335,871

(22) Filed: Oct. 27, 2016

(51) Int. Cl. B60W 40/08; B60W 10/04; B60W 10/20; B60W 10/30; B60W 30/18

(52) U.S. Cl. CPC B60W 40/08; B60W 10/04; B60W 10/20; B60W 10/30; B60W 30/18; B60W 2420/42; B60W 2540/22; B60W 2720/10; B60W 2710/20; B60W 2710/30; B60W 2550/10; B60W 2040/0872

(57) ABSTRACT

A system includes a processor configured to determine an emotional state of a vehicle occupant based on information gathered from a vehicle sensor. The processor is also configured to determine if an emotional state response action has been predesignated for responding to the emotional state and enact the predesignated emotional state response action to alter a physical vehicle characteristic.

### TECHNICAL FIELD

The illustrative embodiments generally relate to a method and apparatus for vehicular adaptation to driver state.

### BACKGROUND

As semi-autonomy progresses in vehicle computing systems, manufacturers are taking ever increasing steps to facilitate automatic situational adaptation to a changing vehicle environment. Adaptive cruise control is a good example of situational adaption in that the cruise control function adaptively slows a vehicle operating in cruise control if approaching a leading-vehicle too quickly.

Other automatic adjustments to a vehicle environment can include, for example, automatically turning on windshield wipers when rain begins, or enabling/disabling safety features such as airbags based on occupancy. As drivers become more comfortable thinking of vehicles as “thinking” machines, this shift in thinking provides new opportunities for vehicular function advancement.

### SUMMARY

In a first illustrative embodiment, a system includes a processor configured to determine a vehicle-occupant emotional state based on information gathered from a vehicle sensor. The processor is also configured to determine if a state-response action has been predesignated for responding to the emotional state and enact the predesignated state-response action to alter a physical vehicle characteristic.

In a second illustrative embodiment, a computer-implemented method includes enacting a predefined change to a vehicle environment, designated for enactment responsive to a particular emotional state, responsive to detection of an occupant emotional state using a vehicle sensor, wherein a plurality of predefined changes are locally stored on a vehicle and correlated to varied emotional states.

In a third illustrative embodiment, a computer-implemented method includes enacting a predefined change to a vehicle environment in a predefined proximity to a location of the passenger originating the detected emotional state, responsive to detection of a predefined passenger emotional state using vehicle sensors.

### BRIEF DESCRIPTION OF THE DRAWINGS

FIG. 1 shows an illustrative vehicle computing system;

FIG. 2 shows an illustrative process for driver state detection and response;

FIG. 3A shows an illustrative process for a first emotional state handling;

FIG. 3B shows an illustrative process for accident preconditioning;

FIG. 4 shows an illustrative process for elective emotional state handling; and

FIG. 5 shows an illustrative process for passenger emotional state handling.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

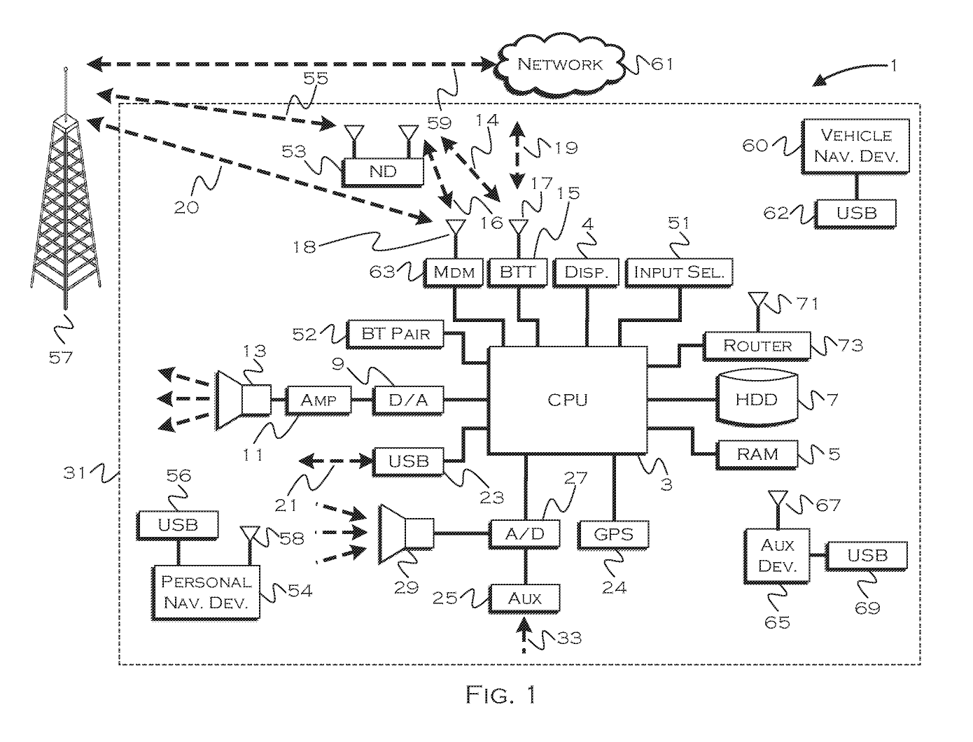

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non- persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Illustrative communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

As users become more comfortable with adaptive “thinking” technology, this provides for new opportunities to improve machine functionality. In the illustrative embodiments, for example, a vehicle will respond to changes in user emotional state. Some of this response is completely transparent-for example, changing traction control to a handling state if a fear emotion is detected (in the hopes that advanced handling helps mitigate a potential accident). Some of the possible responses, on the other hand, are intentionally noticeable to users. For example, it may be the case that a vehicle attempts to “calm” an angry driver by adjusting lighting or music.

At one point in time, people may have found this “behavior” from a vehicle highly intrusive. As people become more accustomed to interacting with machines on a more integrated level, however, the mindset with regards to having a vehicle “calm” a driver or passenger may change. If a user knows that they do not want to drive angrily, but sometimes loses his temper when driving, the user can preset mood lighting and music selection for when a vehicle detects that he is angry. Since the user explicitly requested this behavior from the vehicle, it may seem far less intrusive than, for example, the vehicle attempting to autonomously calm the user. When people become accustomed to this first iteration, however, they may soon find that they are ok with being calmed by their vehicle, opening the door for a more autonomous, non-requested experience. The illustrative examples cover both scenarios, those of non-requested behavior and action taken on behalf of an occupant and those of requested behavior taken at the behest of an occupant.

The vehicle can use various vehicle sensor capability to determine a driver or occupant emotional state. For example, the vehicle may take a baseline image of a particular face, and use that as a reference to determine what variations equate to “angry” or “sad” or other emotions. Known variances in facial features that correspond to each state can be applied to the baseline, and a comparison to a present state can be made to determine if any deviance in the present state from the baseline represents a likely emotional state.

Vehicle microphones can detect stress levels in a driver voice and/or loud input such as yelling or crying. Biometric sensors can detect changes in biorhythm corresponding to changes in user emotional state. The vehicle can take this information, and similar information, alone or in combination, and determine an approximate user emotional state. Depending on whether a user is a passenger or driver, and whether an action has been preconfigured or should automatically apply, the vehicle can then take a responsive action to enhance, mitigate or otherwise address the detected emotional state.

Certain actions may be taken automatically, in some examples, such as those with regards to safety. For example, if the vehicle detects a driver fear-state (which may be represented by a spike in heart-rate or a rapid change to a known fear expression), this could be indicative of an imminent accident. The vehicle could slow (if there is no vehicle immediately behind), the vehicle could change traction control settings to provide better handling, the vehicle could tension seat belts, and take any other number of actions. Actions that affect the vehicle handling may be pre-requested by the driver or otherwise engaged, as those may hinder, rather than help, if unexpected. Actions that simply improve safety, such as tensioning seat belts, may be engaged regardless.

Whether to automatically utilize a particular state change or expressly require user-initiation may be largely a matter of target audience and implementation. The illustrative embodiments contemplate both scenarios, and simply because an illustrative action is described as an automatic action or a requested action does not mean the other paradigm could not be applied to any respective action.

By adaptively modifying physical characteristics of the vehicle (which include, but are not limited to, speed, handling, lighting, music, etc.), positive response to a driver emotional state can be achieved. This can improve the overall driving experience and create a more meaningful vehicular experience for all occupants.

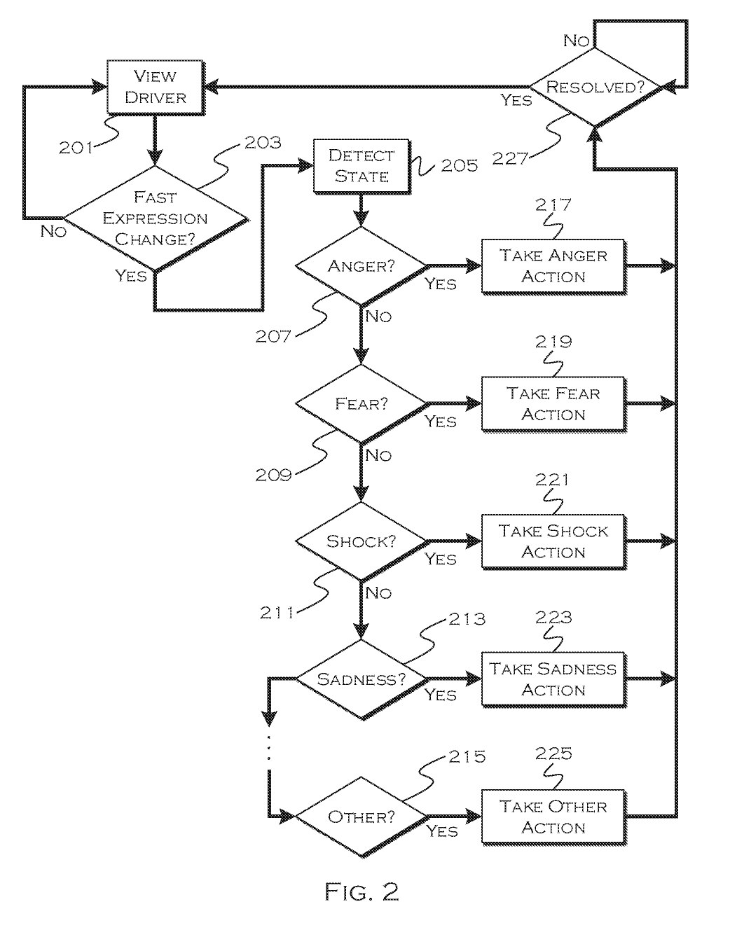

FIG. 2 shows an illustrative process for driver state detection and response. In this illustrative example, the process views (or otherwise senses) the driver 201. If the process detects a “fast expression change,” this is assumed to relate to a change in emotional state. In other examples other sensors may be used, alone or in conjunction with a camera, to detect the onset of an emotional state.

The process analyzes any gathered sensor input (microphone, camera, biometrics, etc.) and determines a likely emotional state 205. For each of the exemplary states and exemplary action is contemplated. An anger state 207 has an anger action 217 corresponding thereto, and fear 209, shock 211 and sadness 213 have similar respective fear 219, shock 221 and sadness 223 actions. Other emotions 215 and corresponding actions 225 are also contemplated.

To the extent that the action is designed to mitigate a state or address a likely incident represented by a state, the process then determines if the desired result has been achieved 227. If not, the action persists or proceeds, otherwise, if the state/incident has been addressed the process can return to monitoring.

Several examples of state-based reactions are provided for illustrative purposes only. It is appreciated that different actions can be automatic or requested for different occupants under different scenarios. It is also appreciated that the state-based actions need not be discretely assigned to a particular state, for some actions, for example, a multi-state trigger may be used (e.g., fear or shock could trigger accident avoidance and preconditioning response).

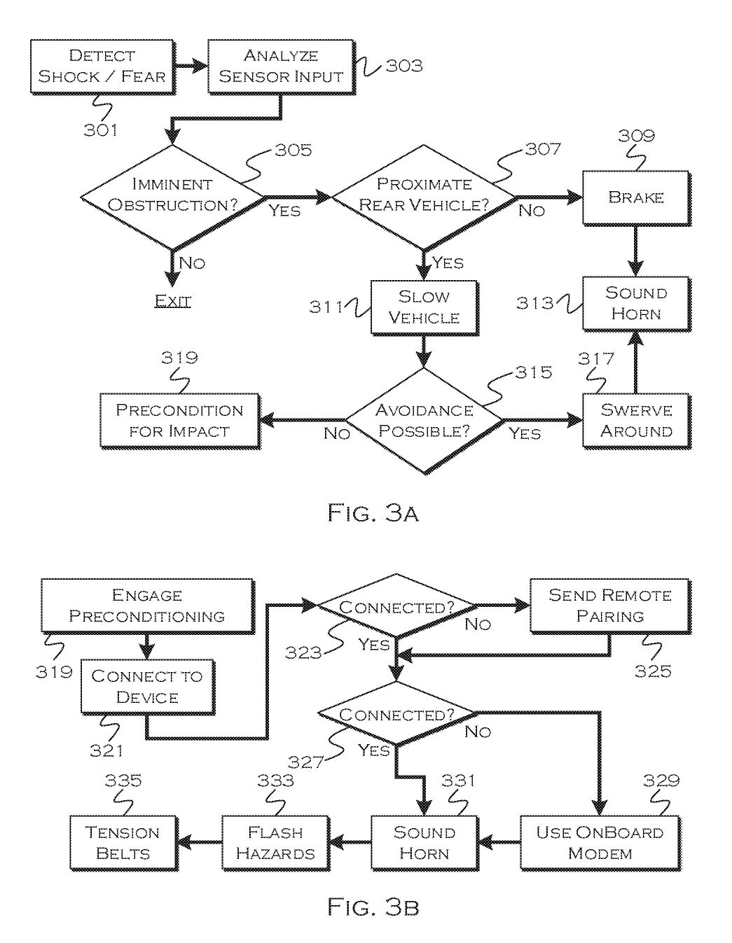

FIG. 3A shows an illustrative process for a first emotional state handling. In this example, the process detects a fear or shock state 301 and engages vehicle-exterior sensors 303. The process uses this sensor input to determine a next-action, such as if a forward obstruction is detected 305. If there is an imminent forward obstruction (collision likely), the process determines if there is a proximate rearward vehicle 307. If there is not a vehicle within a predefined distance and/or moving at a predefined speed to the rear, the process brakes the vehicle aggressively 309 to stop forward progress. Also, in this example, the process sounds the horn 313 to alert the obstruction of a potential imminent collision.

In an alternative example, the process may determine if there is a close rear-ward vehicle, but no forward vehicle, and speed up the vehicle slightly or aggressively. This could avoid a rear collision, the imminence of which resulted in the fear/shock state.

If there is a rearward vehicle, the process may slow the vehicle somewhat 311, but not aggressively, so as to give the immediately rearward vehicle time to react. In this case, since the object vehicle is not stopping, the process may also determine if avoidance is possible 315. This could include, for example, using vehicle sensors to determine if side-ward obstructions are present. If avoidance appears to be possible, based on reasonable sensor data, the process may automatically adjust a vehicle path to swerve around the detected obstruction 317. Again, in this case, the process also sounds the horn 313.

If there is no possibility of avoidance (because, for example, a confidence of data is low or there are side-ward obstructions), the process may precondition the vehicle for a possible impact 319 (e.g., sound a horn, tighten restraints, and engage any accident mitigation features).

If emotional state detection and response is engaged for multiple vehicle occupants, then different action may be taken based on different states observed among different occupants. For example, a driver or front-passenger fear/shock state may result in certain less impactful mitigation response, but other mitigation response affecting handling may only occur when, for example, the driver is not looking forwards (detectable by a camera) and the passenger exhibits fear/shock, or only when a forward looking driver exhibits fear/shock. This could be because a passenger may overreact to a situation that the driver feels is well in hand. On the other hand, if the driver is not looking forward, the passenger's expression could serve as an early warning of a possible accident situation.

Fear and shock may also be indicative of a need to call or contact emergency services. Certain facial configurations may be consistent with the onset of certain medical conditions, and these configurations can be observed and a resulting call or communication to emergency services could result. In other instances, where it may be preferable to wait until the actual accident occurs, to see if the actual accident occurs, the detection of the emotional state can at least cause a system to ensure that the ability to communicate with an emergency operator is enabled. If not enabled, steps can be taken to attempt to enable or reinforce such communication. For example, if fear is observed, the system can determine if a cellular connection through a user device is available, as well as a cellular connection through a vehicle modem. If only the vehicle modem is available, the modem can send a remote pairing instruction to a user phone, to cause pairing of the phone to provide a secondary backup communication channel in the event of an emergency.

If the user phone is the only form of communication (thus no remote pairing request can be sent), the process may instruct the user to pair a phone (although in an instantaneous reaction-situation, this may not really be an option). Other, reasonable action that can mitigate the likelihood of no emergency communication being made can also be taken.

Other emotional states detected for other passengers could have similar responses tailored to where in the vehicle the emotional passenger is located, if determinable. For example, a crying child in the rear seat could cause playback of preselected soothing music through rear speakers.

FIG. 3B shows an illustrative process for accident preconditioning. In this illustrative example, the vehicle detects an emotional state indicative (based on preconfigured parameters) of a likely upcoming accident (e.g., fear, shock, etc.). The process first engages any active safety features to help mitigate damage and/or avoid the accident entirely 319.

Also, in this example, the process attempts to connect to an in-vehicle device for use of the device's cellular signal. Even if the vehicle is equipped with an onboard modem, the modem may be damaged in an accident, so this connection to an in-vehicle device provides either a primary or a backup connectivity option for placing an emergency assistance call.

If the connection attempt between the device and vehicle is successful 323, the process determines if a connection between the vehicle and a remote source (e.g., cellular) can be established through the device 327. If the vehicle cannot connect to the local device (for example, if BLUETOOTH is disabled on the device), the vehicle may send a remote pairing request 325. The remote pairing request is a request sent through the vehicle modem over a cellular network, instructing the device to which the vehicle is attempting to connect to enable the BLUETOOTH functionality.

If there is no available cellular connection through the driver or other occupant device, the vehicle will designate the onboard modem as the primary source for communication 329. Also, in this example, the vehicle takes other mechanical steps to mitigate or avoid an accident, such as sounding a horn 331, flashing hazards 333, tensioning seatbelts 335, etc.

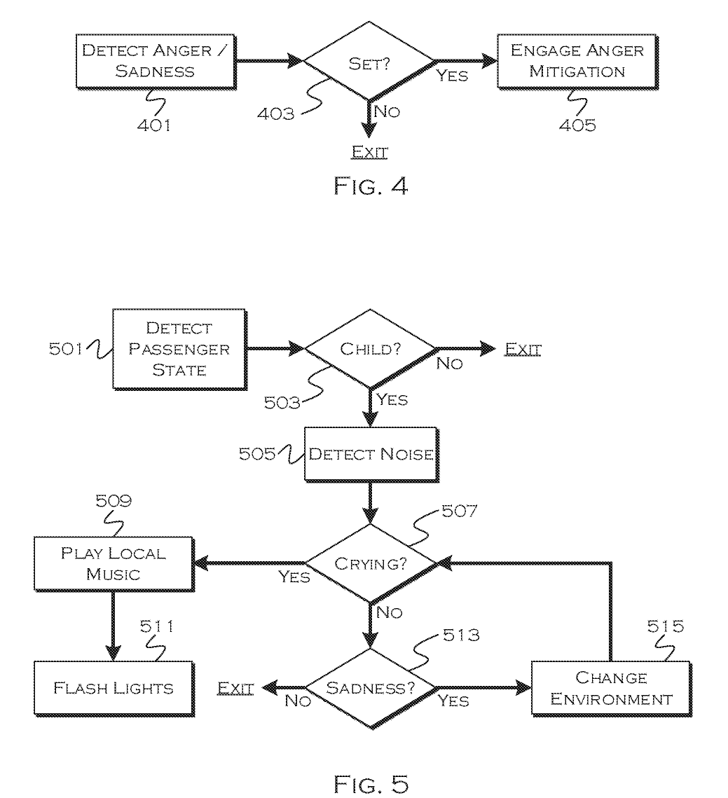

FIG. 4 shows an illustrative process for elective emotional state handling. In this example, the vehicle detects a state that does not indicate an accident or other dangerous scenario, but which may still be desirable to mitigate. Some drivers, for example, may recognize that they get angry when they drive, and may want relaxing music or change in ambient cabin conditions to occur when they are angry.

In other examples, when a driver is excited and driving, the driver may want intense music playing. Settings can be preset 403 for any detected emotional state, and if the settings are preset 403, the predefined action (e.g., anger mitigation) can be taken when the emotional state is detected 405.

FIG. 5 shows an illustrative process for passenger emotional state handling. In this example, an occupant other than the driver is experiencing a detectable emotional state 501. One useful aspect of state detection would be to help avoid parents from being distracted while driving with a child, so the process determines if the entity for which the state detected is a child 503. This could be done by recognition of a previously designated entity, or by facial size recognition, or even weight recognition.

If the process detects an emotional state (such as sadness) for a child, and also detects a noise coming from the child 505, the process will try to correlate the detected information with a predefined mitigation action. Here, if actual crying is detected 507, the process may play some music in the interior locality (e.g., one or two speakers, or all speakers if preferred) of the child 509. The process may also flash vehicle interior lights 511, if safety-appropriate, to distract and engage the child. For older children, the vehicle may play localized media (such as movies or games) if the appropriate output is available and the playback has been preset.

If there is no crying, but a child appears sad or otherwise about to transition to a state potentially distracting to a driver, the process may attempt to change the vehicle environment in some manner (e.g., without limitation, changing temperature, changing window states, changing lighting, etc). Again, a driver or occupant can preset these changes to determine what steps the vehicle takes to attempt to mitigate the situation. It is also possible for the vehicle to learn what actions the driver takes to mitigate personal or child emotional states, store those actions with respect to a user profile, and offer to take those actions when a similar emotional state is detected at a later point in time.

Other opportunities for utilizing emotional states also exist. For example, certain emotional states may correspond to hunger, or may be observed to be mitigated by feeding the actor. In these instances, targeted advertising or routing suggestions may be provided that relate to one or more options for eating. Similar changes to emotional states may be exhibited by other shopping behavior, and advertising correlations as observed to be effective by recorded data relating to user actions following particular emotional states may be saved. These correlations can be used for ad selections and/or routing suggestions to mitigate observed states or address observed states.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
determine an emotional state of a vehicle occupant based on information gathered from a vehicle sensor;
determine if an emotional state response action has been predesignated for responding to the emotional state; and
enact any predesignated emotional state response action to alter a physical vehicle characteristic.

2. The system of claim 1, wherein the vehicle sensor includes a vehicle camera.

3. The system of claim 1, wherein the vehicle sensor includes a vehicle microphone.

4. The system of claim 1, wherein the vehicle sensor includes a biometric sensor.

5. The system of claim 1, wherein the processor is configured to determine that the emotional state corresponds to a fear state and wherein the predesignated emotional state response includes preconditioning a vehicle for an accident.

6. The system of claim 5, wherein the preconditioning includes automatically reducing vehicle speed.

7. The system of claim 5, wherein the preconditioning includes automatically changing a vehicle traction control setting.

8. The system of claim 5, wherein the preconditioning includes automatically steering a vehicle to the side of a detected forward obstruction.

9. The system of claim 1, wherein the processor is configured to determine that the emotional state corresponds to an unhappy state and wherein the predesignated emotional state response includes changing vehicle lighting.

10. The system of claim 1, wherein the processor is configured to determine that the emotional state corresponds to an unhappy state and wherein the predesignated emotional state response includes playing predefined audio.

11. The system of claim 1, wherein the processor is configured to determine that the emotional state corresponds to an unhappy state and wherein the predesignated emotional state response includes playing predefined video.

12. The system of claim 1, wherein the processor is configured to determine that the emotional state corresponds to an unhappy state and wherein the predesignated emotional state response includes playing predefined audio or video on speakers or a display, respectively, assigned to a location of the vehicle occupant exhibiting the emotional state.

13. A computer-implemented method comprising:
responsive to detection of an occupant emotional state using a vehicle sensor, enacting a predefined change to a vehicle environment, designated for enactment responsive to a particular emotional state, wherein a plurality of predefined changes are locally stored on a vehicle and correlated to varied emotional states.

14. The method of claim 13, wherein the change includes a vehicle interior lighting change.

15. The method of claim 13, wherein the change includes a vehicle audio output change.

16. The method of claim 13, wherein the change includes a vehicle video output change.

17. The method of claim 13, wherein the change includes accident preconditioning.

18. The method of claim 13, wherein the plurality of changes include at least accident preconditioning correlated to a fear or shock state and audio or lighting changes correlated to an unhappy state.

19. The method of claim 13, further comprising:
detecting a location of the occupant originating the detected emotional state; and
enacting the change based in part on the detected location.

20. A computer-implemented method comprising:
responsive to detection by one or more vehicle sensors of a predefined emotional state of a passenger, enacting a predefined change to a vehicle environment in a predefined proximity to a location of the passenger originating the detected predefined emotional state.
